(19) United States
(12) Patent Application Publication
(10) Pub. No.: US 2018/0250610 A1
(43) Pub. Date: Sep. 6, 2018

(54) MULTI-MODAL, MULTI-DETECTOR LIQUID CHROMATOGRAPHIC SYSTEM

(71) Applicant: Brigham Young University, Provo, UT (US)

(72) Inventors: Xiaofeng Xie, Provo, UT (US); Luke T. Tolley, Mapleton, UT (US); Paul B. Farnsworth, Orem, UT (US); H. Dennis Tolley, Mapleton, UT (US); Milton L. Lee, Pleasant Grove, UT (US)

(21) Appl. No.: 15/912,364

(22) Filed: Mar. 5, 2018

Related U.S. Application Data
(60) Provisional application No. 62/467,084, filed on Mar. 3, 2017.

(51) Int. Cl. B01D 15/22; G01N 30/60; G01N 30/78; G01N 30/74

(52) U.S. Cl. CPC B01D 15/22; G01N 30/6078; G01N 2030/027; G01N 30/74; G01N 30/78

(57) ABSTRACT

A system and method for performing liquid chromatography for separating molecules in a liquid solution, wherein a single column includes two of more separation segments, each separation segment having a separate detector immediately after each separation segment, wherein a mobile phase is inserted into a first separation segment and moves through the column until passing through a last separation segment, and then using the data from the detectors to perform compound identification.

### BACKGROUND

### Field of the Invention

This invention relates generally to liquid chromatography. More specifically, the invention relates to a system and method for enhancing the ability of a liquid chromatographic system to identify a compound through a plurality of serially aligned columns and detectors.

### Description of Related Art

Liquid chromatography (LC) is performed to analyze and identify the contents of chemicals in a liquid solution by separating molecules. However, since light absorption is usually the detection method used, the ability of LC to positively identify a molecule is limited. For this reason, either a detector that provides more information can be used, such as a mass spectrometer (MS), or additional complementary analysis techniques may be employed to increase the certainty in the identification of a molecule.

These approaches significantly increase the complexity in instrumentation or in the methodology of the separation. Accordingly, there is a need to significantly increase confidence of molecular identification in LC without a significant increase in time, complexity or difficulty. It is believed that this may only be accomplished by gathering more information about an analyte during a single LC analysis run.

### BRIEF SUMMARY

The present invention is a system and method for performing liquid chromatography for separating molecules in a liquid solution, wherein a single column includes two of more separation segments, each separation segment having a separate detector immediately after each separation segment, wherein a mobile phase is inserted into a first separation segment and moves through the column until passing through a last separation segment, and then using the data from the detectors to perform compound identification.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a diagram showing the operation of a UV detection system where UV light is passed through a capillary column.

FIG. 2 is a profile view of a capillary column with two separation segments disposed therein, with on-column detectors disposed after each of the separation segments.

FIG. 3 is a profile view that shows that the single capillary column may have any number of separation segments inside it.

FIG. 4 is a profile view of separate column combination segments that are attached to each other in series to make a single column.

FIG. 5 is a profile view of a capillary column with two separation segments disposed therein but no gap between them, with on-column detectors disposed overlapping each of the separation segments.

FIG. 6 is two graphs showing measurements obtained from two different separation segments disposed in series as in FIG. 2.

FIG. 7 is a table of results from the measurements shown in FIG. 5.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention, and should not be viewed as narrowing the claims which follow.

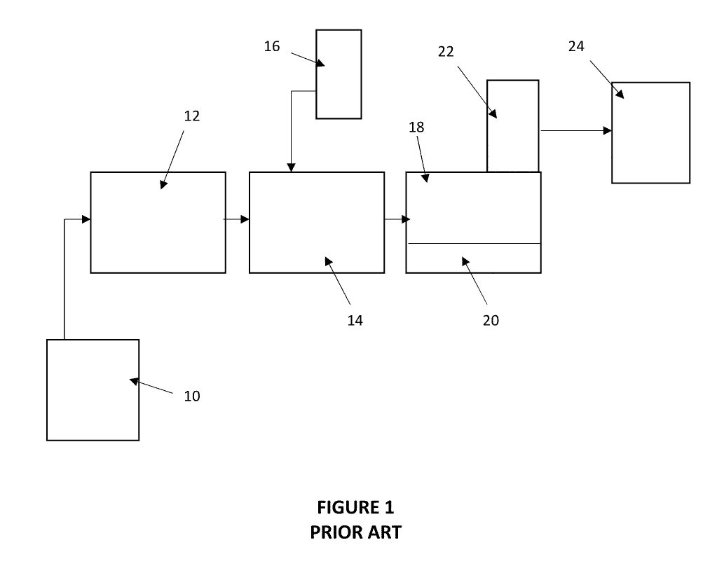

Liquid chromatography (LC) which uses on-column detection is a well-understood and ubiquitous method of analyte separation and detection. FIG. 1 is a block diagram of components that may be part of an LC system in the prior art that may include but should not be considered as limited to a container of solvent 10, a pump 12, an injector 14, a sample 16, a column 18, a heater 20, a detector 22 and a device for data acquisition 24. Other components may also be needed, and the arrangement of specific components may be modified from that shown, but typically these components are used in the sequence shown.

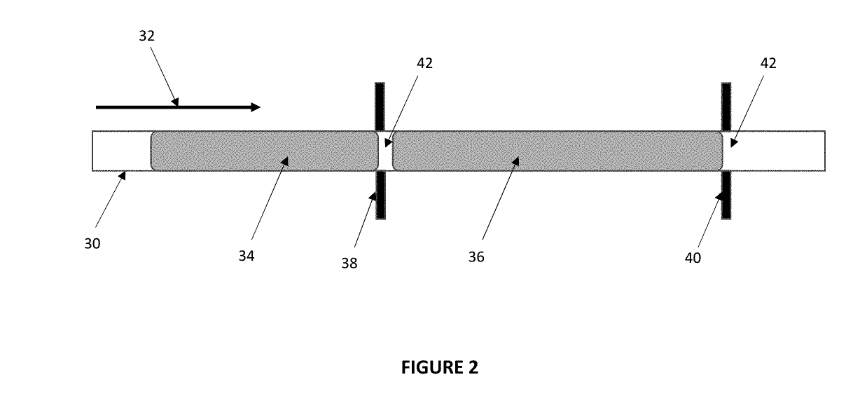

FIG. 2 is a cross-sectional profile view of a capillary column 30 that is made in accordance with the principles of a first embodiment of the invention. The first embodiment may be the capillary column 30. Arrow 32 shows a direction of gradient flow of a liquid through the capillary column 30.

The capillary column 30 may have a plurality of separation segments. The separation segments may be a stationary phase such as a packed bed, a monolithic design or a pillar array. The monolithic design, in chromatographic terms, may be porous rod structures characterized by mesopores and macropores. These pores provide monoliths with high permeability, a large number of channels, and a high surface area available for interaction. The monolithic separation segment may be composed of either an organic or inorganic substrate and can easily be chemically altered for specific applications. Their unique structure gives them several physico-mechanical properties that enable them to perform competitively against traditionally packed columns. In contrast, the pillar array may use chemical etching on an open column having a coating on the column wall and using a porous substrate.

The first embodiment of the invention shows a first separation segment 34, a first detector 38, then a second separation segment 36, and a second detector 40, all in series and in the capillary column 30. The first detector 38 and the second detector 40 are performing on-column detection.

The first separation segment 34 and the second separation segment 36 may contain chromatographic media having a different stationary phase. The chromatographic media may be particles coated with a stationary phase, a monolithic structure, particles with exposed active sites, or any other material that is suitable for LC separations.

The stationary phases may have reversed phase functionality (C18, phenol, etc.), normal phase functionalities (amino, silica, etc.), ion exchange functionality, or any number of alternate functionalities.

While a wide variety of stationary phase options are available for packing in the capillary column 30, the stationary phases that are chosen for inclusion in a single column should all be effective for analyte separate when using the same mobile phase. The purpose of this requirement is that the composition of the mobile phase may not be fundamentally changed between separation segments in the same column.

The first embodiment of the capillary column 30 and the two separation segments 34, 36 shown in FIG. 2 enables non-destructive detection of analytes between the two separation segments. Detection may be in the form of light absorbance such as using a UV absorption system. Other non-destructive methods include, but should not be considered as limited to, contactless conductivity detection, fluorescence detection and refractive index detection. However, any method of non-destructive detection may be used, and any of these detection methods should be within the scope of the first embodiment.

To use on-column non-destructive detection methods, there may be a short segment after each of the two separation segments 34, 36 where the capillary column 30 may have a short capillary detection segment as shown in FIG. 2 at arrows 42.

The capillary detection segments 42 at the end of each separation segment 34, 36 must not only enable detection, but may be designed to have a minimal detrimental effect on the analyte separation that has just occurred. For example, large liquid volumes between the separation segments 34, 36, or before the first separation segment 34 or after the second separation segment 36, may allow sample diffusion and band broadening. Therefore, the first embodiment only provides a small gap forming the capillary detection segments 42 with sufficient volume for on-column detection to be performed and may be the preferred method.

Alternatively, the capillary detection segment 42 may overlap a separation segment at an end thereof and not actually form a physical gap between separation segments.

The following is an example of some dimensions for the elements within the capillary column 30. These dimensions are only an example and should not be considered as limiting of the dimensions that are possible. The capillary column 30 is formed of fused silica and may have an outer diameter of 0.360 mm and may have an inner diameter of 0.150 mm. The first separation segment 34 may be packed with a reversed-phase chromatographic medium of approximately 5 to 10 cm in length, which may then be followed by the empty capillary detection segment 42 of approximately 1 to 2 mm in length. The second separation segment 36 immediately follows the capillary detection segment 42 and may be packed with a different reversed-phase chromatographic medium of approximately 5 to 10 cm in length, which may then be followed by the empty capillary detection segment 42.

The second detector 40 is disposed immediately after the end of the second separation segment 36 and therefore the remaining length of the empty capillary column 30 is not relevant.

The capillary detection segments 42 are of sufficient size and physical properties to enable ultraviolet light (UV) absorbance (or other detector property) measurements to be made. For example, when performing UV light absorbance detection, the capillary detection segments 42 may be transparent to UV light. Thus, the capillary detection segments 42 may have whatever properties are needed for the selected detection method to function properly.

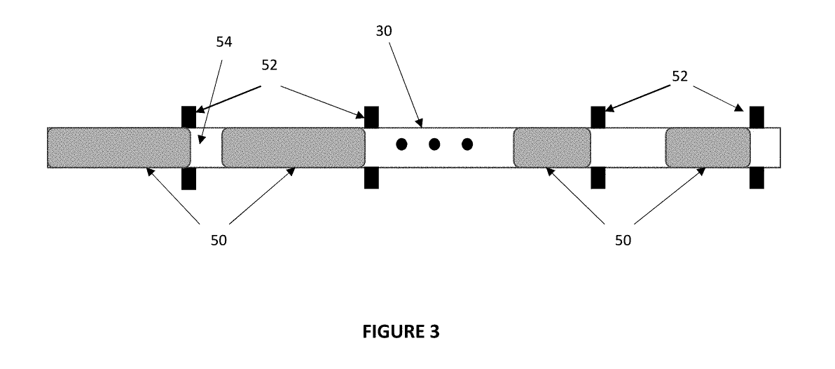

It should be understood that the first embodiment of the invention shown in FIG. 2 may be modified as shown in the second embodiment in FIG. 3. FIG. 3 is a profile view that shows that the single capillary column 30 may have disposed therein any number of separation segments 50 (as indicated by the ellipses), wherein each of the separation segments has a detector 52 disposed immediately adjacent to the end of the separation segments at a small capillary detection segment 54 or overlap the separation segments if detection is possible through the separation segments. Thus, while the first embodiment may be limited to two separation segments 34, 36 and two detectors 38, 40, any number of separation segments 50, detectors 52 and capillary detection segments 54 may be formed in series to provide the functionality of the embodiments of the present invention.

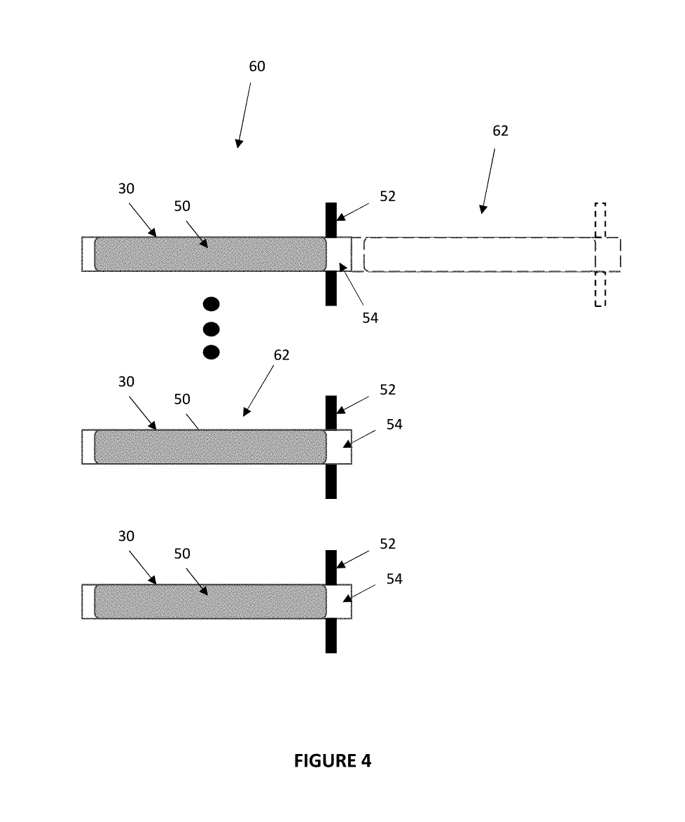

FIGS. 2 and 3 are directed to the first and second embodiments using a single capillary column. FIG. 4 is provided as a profile view of a plurality of separate column combination segments 60. Each column combination segment 60 includes a capillary column 30, a separation segment 50, a detector 52 and a capillary detection segment 54. These column combination segments 60 may be packed with different chromatographic media, and then combined in series in any desired order as indicated by the column combination segments 62 shown in solid lines before it is disposed against an end of the first column combination segments 60 and shown in dashed lines.

Thus, the fourth embodiment of the invention enables separation of analytes using any specific chromatographic media and with any type of detector and in any desired order. The column combination segments 60 may be joined together using any joining method that does not interfere with the movement of the analytes from one column combination segment 60 to another.

It should be understood that the capillary detection segments 54 may vary in length, may overlap the separation segments, or may not even be present at each end of each column combination segment 60. What is important is that the capillary detection segment 54 is provided at any end that is coupled to another column combination segment 60 so that a detector may be disposed on the capillary detection segment and thereby perform detection measurements.

There may be some significant differences that may not be apparent between the prior art tandem liquid chromatography (LC/LC or LC×LC) and the embodiments of the invention. One difference may be that conventional state-of-the-art LC/LC and LC×LC are performed using different mobile phase compositions in each column. In contrast, there is a single mobile phase that passes from each separation segment to the next in a single column.

Another difference is that the prior art may require a complicated switching mechanism to transfer discreet sequential volumes from a first column (or segment) to a second column or segment.

Another significant different may be that each analysis in the second-dimension finishes before a subsequent volume from the first column (or segment) is transferred to the second segment, with the result being that the first column is typically long and slow and the second is short and fast. While LC/LC and LC×LC may provide useful information, the overall system is slow and complex.

Regarding detectors, non-destructive detectors may be disposed on the capillary detection segments between separation segments and after the last separation segment at the end of the column to generate chromatograms corresponding to elution of analytes from each separation segment.

As stated previously, many types of detectors may be used, although UV absorbance detection may be the most common method. Regardless of which detector is used, the detector should be compact and sensitive enough to allow for on-column detection with minimal impact on bandwidth. Data from each detector are then recorded to determine the effect that each separation segment in the column has on each analyte.

Referring to the first embodiment shown in FIG. 2, two separation segments 34, 36 in a capillary column 30 are utilized with a first UV detector 38 between the separation segments and the second detector 40 at the end of the second separation segment. This arrangement of separation segments may generate two chromatograms. The first detector 38 may report the sample separation in the first separation segment 34, starting from a mixture of all the compounds in the sample, which would then provide specific retention times and peak shapes for each compound.

All compounds in the sample do not enter the second separation segment 36 at the same time (in contrast to what occurred in the first separation segment 34). Because compounds elute at different times from the first separation segment 34 and proceed into the second separation segment 36, it may be possible to use the output from the first detector 38 to determine when each compound was introduced into the second separation segment 36. By correlating this information with the chromatogram from the second separation segment 36, the retention factor for each compound in the second separation segment 36 may be calculated.

In addition to retention time information, any change in peak shape of each compound eluting at the end of each separation segment 34, 36 may be measured. Compounds may concentrate (sharp peaks), diffuse (broad peaks), or lag behind (give asymmetric peaks) when passing through different stationary phases. Correlating this type of information between the two chromatograms may help with compound identification.

The detectors 38, 40 used after the different separation segments 34, 36 may be identical; however, using detectors with different attributes may provide more definitive identification of the compounds. Each detector may generate a chromatogram; however, the detector response to each analyte would not be the same for different detectors.

For example, if two UV detectors were used, each with a different wavelength, the absorbance at each wavelength, or the ratio of absorbances, may provide some discrimination between compounds having similar elution times. The information generated by this arrangement may be increased if the molecular attributes measured by the two detectors are not correlated.

Sophisticated processing techniques may use all the data gathered, i.e., retention times on each separation segment, responses from each detector, peak shapes from each separation segment, etc., to provide an identification of a molecule with much greater accuracy than would be achieved using a traditional LC system.

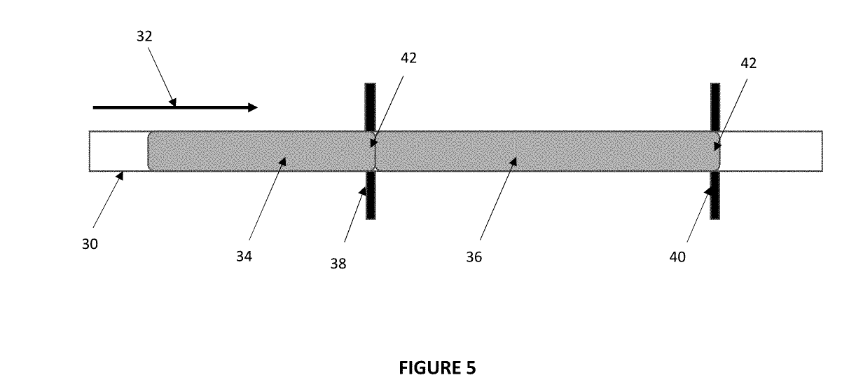

FIG. 5 is a cross-sectional profile view of a capillary column 30 that is made in accordance with the principles of another embodiment of the invention that is similar to the first embodiment shown in FIG. 2. However, one significant difference is that the capillary detection segments 42 and thus the first detector 38 and the second detector 40 are now overlapping the separation segments 34, 36 respectively. This is only possible where the structure in the separation segments 34, 36 do not interfere with the detectors 38, 40. In addition, there is no gap between the separation segments 38, 40.

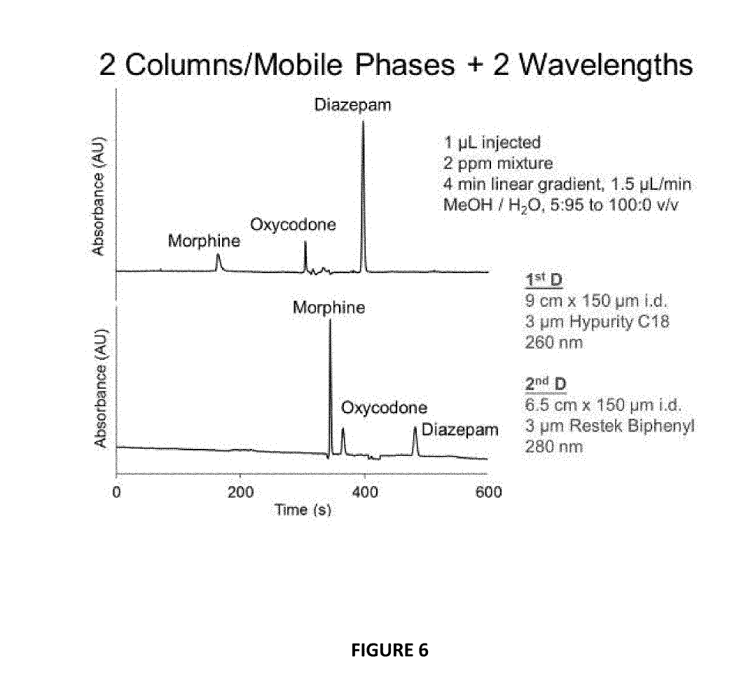

FIG. 6 shows test results from an LC system as described in the first embodiment of the invention. The UV detectors used two different wavelengths when performing measurements. The first detector 38 used a wavelength of 260 nm, and the second detector 40 used a wavelength of 280 nm.

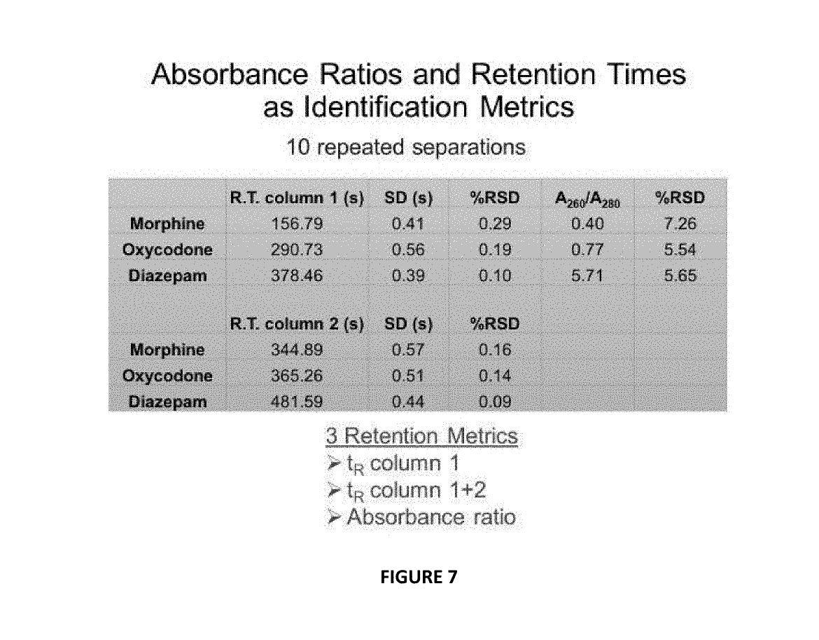

FIG. 7 is provided as a table showing absorbance ratios and retention times as identification metrics of the different compounds. The results show that the measurements and analysis of the compounds are easy to perform, there is increased specificity with two dimensions and two wavelengths, and information from both dimensions may be used.

In this document, on-column detection may refer to when packed bed material in the separation segments terminates before the end of the column so that the last part of the column is actually empty. But there may also be situations in which the column has packed bed material all the way to the end of the column and a capillary has to be added in order to perform detection in the capillary portion. Accordingly, the embodiments of the invention should all be considered to include both configurations to be within the scope of all embodiments, where detection is taking place on-column in an area of the column that does not contain packed bed material, or within a capillary that has been added to the very end of the column where the packed bed material ends.

In the first embodiment of the invention, the embodiment may use an LED-based UV absorption detector with low detection limits for use with capillary liquid chromatography. In a first aspect of the first embodiment, an LED light source may be selected wherein the LED output wavelength may change with changes in drive current and junction temperature. Therefore, LEDs should be driven by a constant current supply, and heating of the system should be avoided.

The quasi-monochromaticity of the LED source contributes to stray light in the system, leading to detector non-linearity. The detection system should be protected from any LED light outside the desired absorption band by employing a filter in the system.

On-column capillary detection may be preferred for capillary columns, since narrow peak widths are obtained by eliminating extra-column band dispersion, and peak resolution is maintained. The short-term noise in the detector may determine the detection limits and may be generally reduced by performing integration, smoothing, and/or using low-pass RC filters.

It is also noted that the first embodiment shows that UV LED-based absorption detectors have great potential for miniaturization for field analysis. Further optimization of the detector design and reduction in the noise level may lead to better detection limits for small diameter capillary columns. The system is relatively small, light-weight and has very low power consumption compared to the prior art.

The system for analyzing absorption may be part of the detector or may be a computer system that is coupled to the detection system for receiving data from the detector.

It is also noted that the first embodiment performs on-column LC detection using a monolithic capillary column. Using on-column detection may improve peak shapes and increase detection sensitivity because extra-column band broadening may be reduced.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A column for performing capillary liquid chromatography, said system comprising:
a capillary column;
a first separation segment disposed in the capillary column and comprised of a first chromatographic media;
a first capillary detection segment in the capillary column immediately adjacent to an end of the first separation segment;
a first detector for on-column detection through the first capillary detection segment;
a second separation segment disposed in the capillary column adjacent to the first capillary detection segment and comprised of a second chromatographic media;
a second capillary detection segment in the capillary column immediately adjacent to an end of the second separation segment; and
a second detector for on-column detection through the second capillary detection segment.

2. The system as defined in claim 1 wherein the first detector is further comprised of a system for analyzing absorption of UV light by at least one compound disposed in a liquid within the capillary column by analyzing the UV light that is received by the first detector that passes through the capillary column.

3. The system as defined in claim 1 wherein the second detector is further comprised of a system for analyzing absorption of UV light by at least one compound disposed in a liquid within the capillary column by analyzing the UV light that is received by the second detector that passes through the capillary column.

4. The system as defined in claim 1 wherein the first and second detector are selected from the group of detectors comprised of a UV absorption system, contactless conductivity detection, fluorescence detection, refractive index detection and electrochemical detection.

5. The system as defined in claim 1 wherein the first capillary detection segment overlaps an end of the first separation segment and the second capillary detection segment overlaps an end of the second separation segment such that there are no gaps between the first separation segment and the second separation segment.

6. The system as defined in claim 1 wherein the first separation segment and the second separation segment are selected from the group of separation segments comprised of packed beds, monolithic design and pillar array.

7. A column for performing capillary liquid chromatography, said system comprising:
a capillary column; and
at least two separation segments within the capillary column, wherein each separation segment includes a chromatographic media, a capillary detection segment after the chromatographic media, and a detector for performing on-column detection through the capillary detection segment.

8. The system as defined in claim 7 wherein the system further comprises a transparent capillary detection segment.

9. The system as defined in claim 8 wherein the detector is selected from the group of detectors comprised of a UV absorption system, contactless conductivity detection, fluorescence detection, refractive index detection and electrochemical detection.

10. A column for performing capillary liquid chromatography, said system comprising:
a capillary combination segment comprised of a chromatographic media, a capillary detection segment after the chromatic media, and a detector for performing on-column detection through the capillary detection segment; and
two of more capillary combination segments connected in series such that the same mobile phase passes through the two or more capillary combination segments.

11. The system as defined in claim 10 wherein the detector is selected from the group of detectors comprised of a UV absorption system, contactless conductivity detection, fluorescence detection, refractive index detection and electrochemical detection.

12. A method for performing capillary liquid chromatography, said method comprising:
providing a capillary column having an insertion end and a termination end, and providing at least two separation segments within the capillary column, wherein each separation segment includes a chromatographic media, a capillary detection segment after the chromatographic media, and a detector for performing on-column detection through the capillary detection segment;
inserting a mobile phase into the capillary column at the insertion end;
generating a chromatogram from each of the detectors to show separation of compounds in the mobile phase after the mobile phase reaches the termination end; and
correlating the chromatogram from each detector to thereby perform compound identification.

13. The method as defined in claim 12 wherein the method further comprises selecting the detector from the group of detectors comprised of a UV absorption system, contactless conductivity detection, fluorescence detection, refractive index detection and electrochemical detection.

14. The method as defined in claim 12 wherein the method further comprises using retention times on each separation segment, responses from each detector, and peak shapes from each separation segment to thereby provide identification of compounds in the mobile phase.

15. A method for performing capillary liquid chromatography, said method comprising:
providing a capillary combination segment comprised of a chromatographic media, a capillary detection segment after the chromatic media, and a detector for performing on-column detection through the capillary detection segment;
providing two of more capillary combination segments connected in series such that the same mobile phase passes through the two or more capillary combination segments beginning at a first capillary combination segment and terminating at a last capillary combination segment;
inserting a mobile phase into the first capillary combination segment;
generating a chromatogram from each of the detectors to show separation of compounds in the mobile phase after the mobile phase reaches the last capillary combination segment; and
correlating the chromatogram from each detector to thereby perform compound identification.

16. The method as defined in claim 15 wherein the method further comprises selecting the detector from the group of detectors comprised of a UV absorption system, contactless conductivity detection, fluorescence detection, refractive index detection and electrochemical detection.

17. The method as defined in claim 16 wherein the method further comprises using retention times on each capillary combination segment, responses from each detector, and peak shapes from each capillary combination segment to thereby provide identification of compounds in the mobile phase.

18. The method as defined in claim 15 wherein the method further comprises:
making the first capillary detection segment overlap an end of the first separation segment; and
making the second capillary detection segment overlap an end of the second separation segment such that there are no gaps between the first separation segment and the second separation segment.

19. The method as defined in claim 15 wherein the method further comprises selecting the first separation segment and the second separation segment from the group of separation segments comprised of packed beds, monolithic design and pillar array.
